(19) United States
(12) Patent Application Publication
(10) Pub. No.: US 2022/0062798 A1
(43) Pub. Date: Mar. 3, 2022

(54) FILTER ASSEMBLY WITH LATERAL REMOVAL OF TIE RODS, AND ASSOCIATED METHOD

(71) Applicant: OVIVO INC., Montreal (CA)

(72) Inventor: Trevor Robert Auman, Sandy, UT (US)

(73) Assignee: OVIVO INC.

(21) Appl. No.: 17/005,875

(22) Filed: Aug. 28, 2020

(51) Int. Cl. B01D 25/00; B01D 25/12

(52) U.S. Cl. CPC B01D 25/002; B01D 25/12

(57) ABSTRACT

A wastewater filter assembly has a base, a filter module or casing, modular filter plates disposed in said filter module or casing atop the base, a header disposed on the filter module, tie rods each coupled at a lower end to the base, and tensioning elements removably connected to upper ends of the tie rods to fix the tie rods to the filter module and press the filter plates into relative rigid relationship. The tie rods are disposed in laterally open elongate channels extending along vertical edges of the filter module. The tie rods, upon a loosening or removal of the respective tensioning elements, can be shifted at least partially in a horizontal direction out of the laterally open elongate channels and laterally away from the filter module.

### BACKGROUND OF THE INVENTION

The present invention relates to modular filter plate assemblies for wastewater and water treatment applications. The invention also relates to an associated method for use in wastewater and water treatment applications.

Typical filter assemblies that are lowered into wastewater treatment tanks include a basic frame/box and an integrated header holding modules or casings of SiC membrane filter plates. The filter modules or casings key into each other with male-female couplings and an interposed gaskets. To remove a module the stack has to be slightly lifted. Once the stack is lifted a little the module can be lifted and pulled out laterally. Alternately a set of modules could be removed from the top.

The stacked filter-plate modules or casings of these box-type modular filter assemblies have aligned holes for tie rods to be inserted down from the top. In some versions these rods can be seen from the outside, while in other versions the rods are enclosed in their entireties in the module body itself.

A problem with such current designs is that the modules have to be unstacked all the way to the top or the rods have to be removed all the way out the top, which requires a substantial amount of head clearance. Otherwise the stack must be keyed together from module to module. This last option is workable, but as the stack gets bigger the load on each subsequent layer gets larger and makes it nearly impossible to economically design a stack that can be lifted from the top requiring an unsafe and blind lift from the bottom of the stack in a tank that has unclear liquid making it hard to see and manage the lift and connection.

### SUMMARY OF THE INVENTION

An assembly for filtering water in wastewater and water treatment applications comprises, in accordance with the present invention, a base, at least one filter module or casing, a plurality of modular filter plates disposed in the filter module or casing atop the base, a header disposed on the filter module or casing, a plurality of tie or clamping rods each coupled at a lower end to the base, and a plurality of tensioning elements removably connected to upper ends of respective ones of the tie or clamping rods. The tensioning elements fix the tie or clamping rods to the filter module or casing and press the filter module or casing into rigid relationship with the base. The tie or clamping rods are disposed along an outer side of said filter module or casing so that at least one of the tie or clamping rods can be moved at least partially laterally away from the filter module or casing upon a loosening or removal of a respective one of said tensioning elements from the at least one tie or clamping rod.

Typically, the assembly includes a plurality of filter modules or casings disposed in a stacked relationship with each other, each of the filter modules or casings containing a number of filter plates. The tensioning elements and the tie rods cooperate to press all of the filter modules or casings into rigid relationship with each other and with the base.

Pursuant to a feature of the present invention, the filter module or casing is provided along an outer side or surface with at least one laterally open elongate channel. The laterally open elongate channel extends vertically from the base to the top of the filter module or casing. At least one of the tie or clamping rods is disposed in and traverses the laterally open elongate channel so that the one tie or clamping rod, upon a loosening or removal of a respective tensioning element from the one tie or clamping rod, the tie or clamping rod can be shifted at least partially, or principally, in a horizontal direction out of the laterally open elongate channel and laterally away from the filter module.

Pursuant to a feature of the present invention, wherein each of the tie or clamping rods is provided at an upper end with an external screw thread, the tensioning elements having bores with internal screw threads so that the tensioning elements screwingly mate with the upper ends of the tie or clamping rods.

The header includes at least one permeate cap, one or more tie or clamping rods releasably fixing the permeate cap to the filter module or casing. To that end, the permeate cap is provided with one or more through-holes, with the one or more tie or clamping rods traversing respective ones of the through-holes.

Preferably, the filter module or casing has a rectangular or square horizontal cross-section, with four vertically extending edges. (Concomitantly, the filter plates are rectangular or square.) The tie or clamping rods may be four in number and are optionally located at the vertically extending edges of the filter module or casing. Each of the tie or clamping rods is located in a respective outwardly or laterally open elongate recess at a respective vertically extending edge of the filter module or casing.

The permeate cap may be one of two modular permeate caps located along respective opposing edges of the filter module or casing. Preferably, each of the two permeate caps has two holes spaced from one another, the through-hole being one of the holes. The tie or clamping rods are connected to respective tensioning elements via respective ones of the holes in the permeate caps.

It is contemplated that at least the at least one tie or clamping rod has its lower end screwably inserted into a vertically oriented recess or seat in the base. Then the lateral moving of the one tie or clamping rod includes a turning and a concomitant vertical shifting of the tie or clamping rod, enough to enable a moving of the tie or clamping rod horizontally away from the filter module. The lateral moving of the tie or clamping rod optionally entails a pivoting of the tie or clamping rod about its lower end.

Preferably, the tensioning elements include a loop or hook, thereby enabling an entrainment of the tie or clamping rods via the tensioning elements and further enabling a lifting of the entire assembly.

A method for use in wastewater and water treatment applications comprises, in accordance with the present invention, providing a filter assembly including a base, a filter module or casing, a plurality of modular filter plates disposed in the filter module atop the base, a header disposed on top of the filter module, a plurality of tie or clamping rods each coupled at a lower end to the base, and a plurality of tensioning elements. The method further comprises removably connecting the tensioning elements to upper ends of respective ones of the tie or clamping rods to fix the tie or clamping rods to the filter module and to press the filter module or modules into rigid relationship with the base. The method may also comprise subsequently removing one or more of the tensioning elements from the upper ends of respective ones of the tie or clamping rods, and thereafter moving the respective tie or clamping rod(s) laterally away from the filter module. A maintenance or repair operation may then be conducted on the filter module or one or more of the filter plates, and afterwards the one or more tie or clamping rods are moved back towards the filter module, with the one or more removed tensioning elements being subsequently reattached to the upper ends of the respective tie or clamping rods.

The maintenance or repair operation may include shifting one or more of the filter plates relative to other ones of the filter plates lower in the filter module.

Pursuant to another feature of the inventive method, the filter module is provided along an outer side or surface with at least one laterally open elongate channel extending vertically along the outer side or surface. The moving of a given tie or clamping rod back towards the filter module includes inserting the given tie or clamping rod into a respective laterally open elongate channel of the filter module.

The moving of the one or more tie or clamping rods laterally away from the filter module may entail pivoting each tie or clamping rod about a respective lower end thereof.

A stacked modular filter-plate assembly pursuant to the present invention, with side-moving tie rods, allows a top lift, facilitates maintenance of a stack that is mounted from the top, and provides for a much more sturdy stack for when the stack is in operation.

### BRIEF DESCRIPTION OF THE DRAWINGS

FIG. 1A is a perspective view of an assembly for filtering water in wastewater and water treatment applications, showing tensioning elements with loops connected to upper ends of respective tie or clamping rods.

FIG. 1B is a side elevational view of the assembly of FIG. 1A.

FIG. 2A is a view similar to FIG. 1A, with external reinforcement truss work removed for simplification, and with the tensioning elements separated from the upper ends of respective tie or clamping rods, thus showing a step in a method of use of the assembly of FIGS. 1A and 1B.

FIG. 2B is a side elevational view of the partially disassembled assembly of FIG. 2A.

FIG. 3A is a view similar to FIG. 2A, additionally showing removal of two permeate caps of the assembly of FIGS. 1A and 1B, a further step in a method of use of the assembly of FIGS. 1A and 1B.

FIG. 3B is a side elevational view of the partially disassembled assembly of FIG. 3A.

FIG. 4A is an exploded perspective view similar to FIG. 2A, with external reinforcement truss work removed, showing a further step in a method of use of the assembly of FIGS. 1A and 1B.

FIG. 4B is a side elevational view of the partially disassembled assembly of FIG. 4A.

FIG. 5 is a partial perspective view, on a larger scale and with external reinforcement truss work removed, of the filter assembly of FIGS. 1A and 1B.

FIG. 6 is a perspective view, with external reinforcement truss work removed, of a filter module or casing containing filter plates and included in the assembly of FIGS. 1A and 1B.

FIG. 7 is a perspective view of a filter plate disposed in filter module or casing as shown in FIGS. 1A, 2A, 3A, 4A, 5, and 6.

FIG. 8 is a perspective view of another wastewater filtering assembly in accordance with the present invention.

FIG. 9 is a partial, broken away, perspective view of the wastewater filtering assembly of FIG. 8, on an enlarged scale.

FIG. 10 is a schematic side elevational view of an alternative method for coupling tie or clamping rod to a base as depicted in FIGS. 1A, 1B, 2A, 2B, 3A, 3B, 4A, 4B.

### DETAILED DESCRIPTION

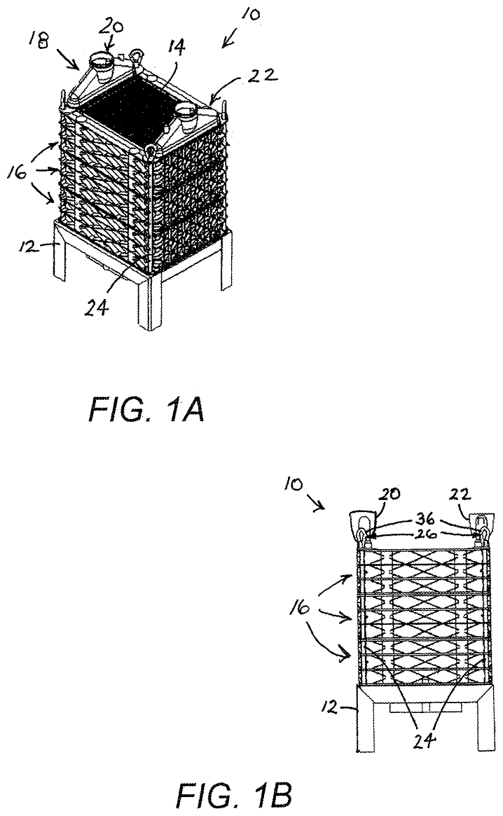

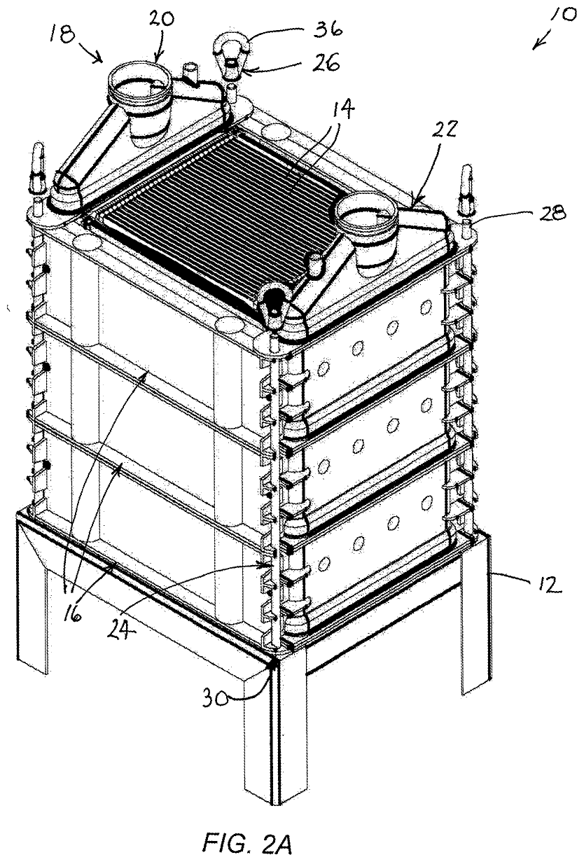

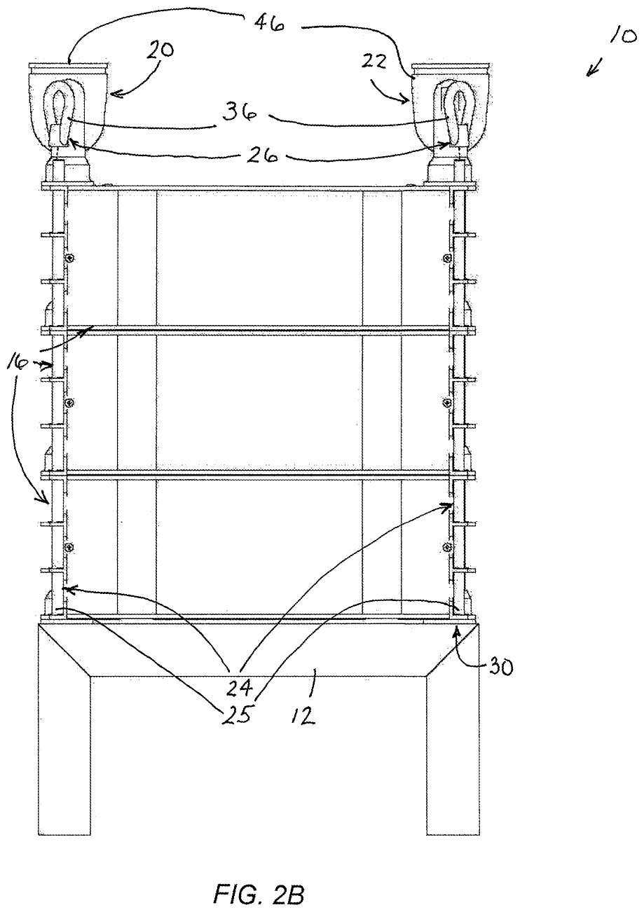

As depicted in FIGS. 1A and 1B, an assembly 10 for filtering water in wastewater and water treatment applications comprises a base 12 and a plurality of modular filter plates 14 disposed in a plurality of filter modules or casings 16 (three shown) in a stack atop the base. A header 18 in the form of two permeate caps 20 and 22 is disposed at an upper end of filter stacked modules or casings 16. Four tie or clamping rods 24 are each coupled at a lower end to base 12. The coupling of rods 24 to base 12 may be effectuated by screwing threaded lower ends 25 (FIGS. 3A, 3B) of the rods into respective threaded recesses or seats (not shown) in the base.

Four tensioning elements 26 are removably connected to upper ends 28 of respective tie or clamping rods 24. Tensioning elements 26 cooperate with tie or clamping rods 24 to fix filter modules or casings 16 into rigid relationship with each other and with base 12. Filter modules or casings 16 are each provided along outer side surfaces (not separately labeled) with at least one and preferably four laterally open elongate channels 30 extending vertically between base 12 and the top of the assembly. Tie or clamping rods 24 are disposed in, and longitudinally traverse, respective laterally open elongate channels 30.

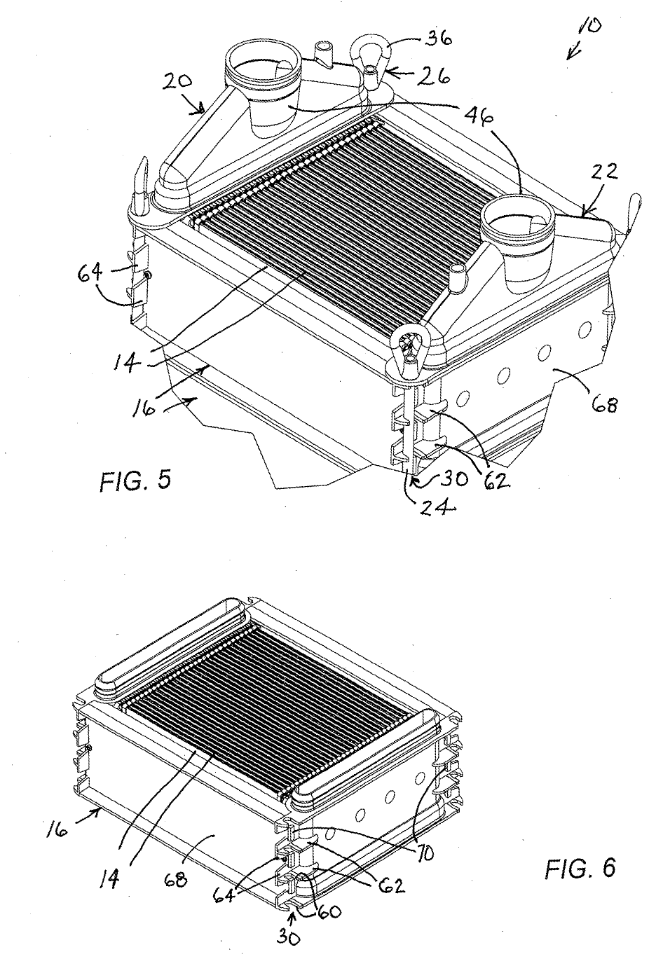

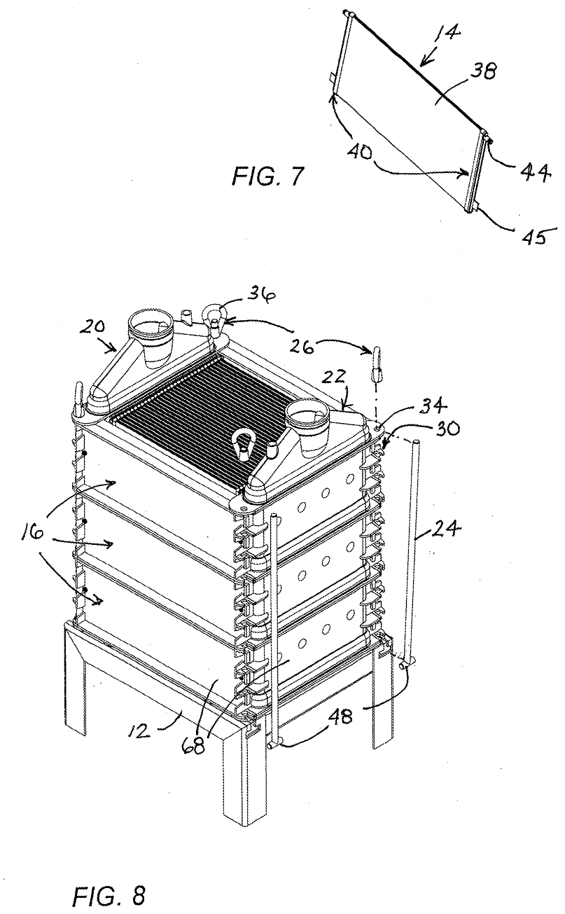

As illustrated with greater clarity in FIGS. 8 and 9, laterally open elongate channels 30 are defined by a series of aligned slots or cutouts 60 in respective horizontal planar elements 62 connected to respective vertical planar elements 64 of respective brackets 66. Brackets 66 are fixed to respective filter modules or casings 16. As further illustrated in FIGS. 8 and 9, filter modules or casings 16 comprise a plurality of mutually coupled planar vertical wall panels 68 releasably coupled to each other for maintenance and repair exemplarily via a plurality of fasteners 70. Tie or clamping rods 24 may implement an ancillary function of restraining fasteners 70 and thereby ensuring the integrity of filter modules of casings 16.

Each filter module or casing 16 typically has the shape of a right rectangular prism, while filter plates 14 are rectangular or square. Preferably, channels 30 and their respectively seated tie rods 24 are located along vertical edges (not separately designated) of filter modules or casings 16. However, channels 30 and tie or clamping rods 24 positions may be spaced from the edges of the filter modules or casings 16, for instance, ⅓ to ¼ the distance between the vertical edges or corners of filter modules or casings 16.

Each tie or clamping rod 24 has its upper end 28 externally screw-threaded. Tensioning elements 26 have bores with internal screw threads (not shown) so that tensioning elements 26 screwingly mate with the threaded upper ends 28 of tie or clamping rods 24. Preferably, tensioning elements 26 each include a loop or hook 36, thereby enabling an entrainment of tie or clamping rods 24 via the tensioning elements and further enabling a lifting of the entire assembly, for immersion into a wastewater treatment tank or removal therefrom.

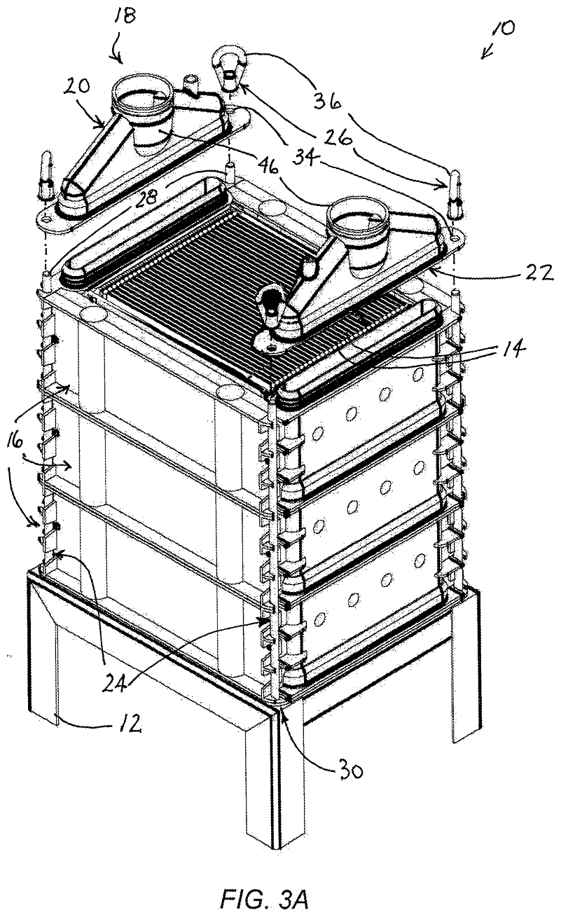

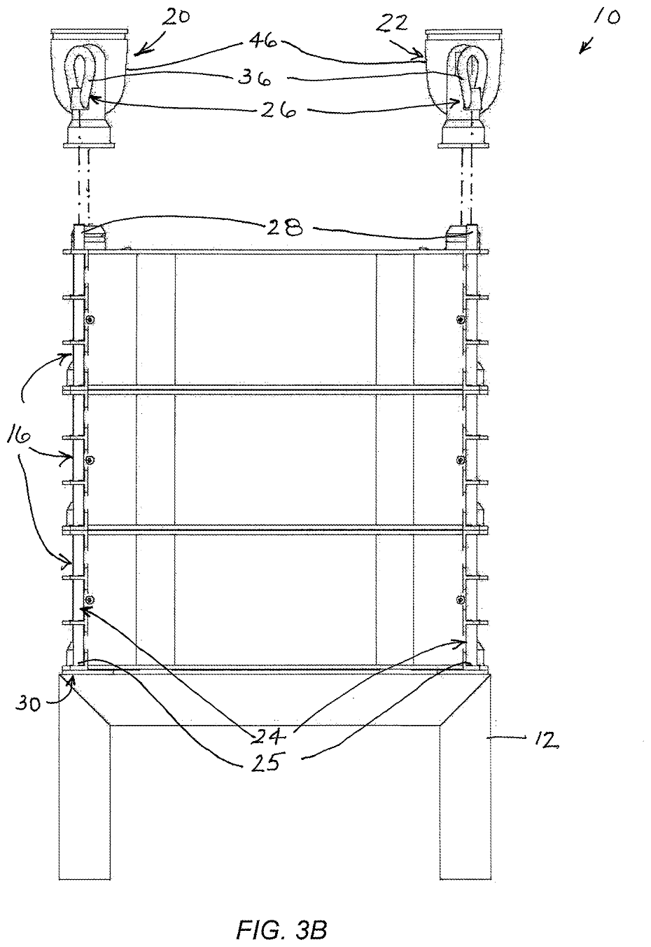

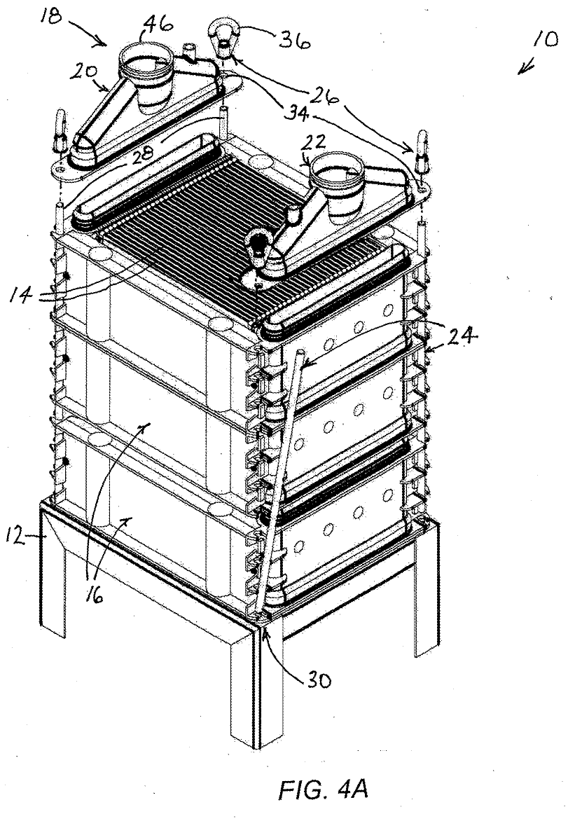

Tie or clamping rods 24 releasably fix permeate caps 20 and 22 to filter modules or casings 16. To that end, permeate caps 20 and 22 are provided with through-holes 34 (FIG. 3A and 4A) through which upper ends 28 of respective tie or clamping rods 24 are coupled to tensioning elements 26.

Filter assembly 10 is typically lowered by means of loops or hooks 36 into a wastewater treatment tank (not shown). As indicated above, tensioning elements 26 are removably connected to upper ends 25 of respective tie or clamping rods 24 to cooperate with the tie or clamping rods to press filter modules or casings 16 into rigid relationship with each other and with base 12. Pursuant to well-known procedures, filter assembly 10 is operatively connected to a vacuum source (not illustrated) for sucking wastewater from the tank or other wastewater container and through membranes of filter plates 14.

To repair or maintain assembly 10, one unscrews at least two, and preferably all four, tensioning elements 26 from upper ends 28 of the respective tie or clamping rods 24, as depicted in FIG. 3A. With a removal of tensioning elements 26 from tie or clamping rods 24, as depicted in FIGS. 3A and 3B, permeate caps 20 and 22 may be lifted and removed from stacked filter modules or casings 16. Then, tie or clamping rods 24 can be shifted at least partially in a horizontal direction and out of the respective laterally open elongate channel 30, laterally away from filter modules 16. If lower ends 25 of tie or clamping rods 24 are inserted in respective recesses or seats in base 12, the lateral or horizontal shifting of a given tie or clamping rod 24 away from filter module 16 is typically preceded by a vertically upward displacement of the given tie or clamping rod (e.g., via an unscrewing operation) to sufficiently extract the lower end of the given tie or clamping rod 24 from base 12. This limited vertical shifting or tie or clamping rods 24 out of and away from base 12 is indicated in FIGS. 4A and 4B, showing a vertical displacement of upper ends 28 of tie or clamping rods 24 relative to stacked filter modules 16.

As illustrated in FIGS. 4A and 4B, the lateral shifting of a given tie or clamping rod 24 may comprise a pivoting of the rod about its lower end 25 at base 12, which may incidentally facilitate the reinsertion of the lower end of the given tie or clamping rod into base 12, where the lower end 25 of the rod 24 is retained in position at the base 12. Alternatively, tie or clamping rods 24 may be completely removed from the base 12 and temporarily held at a position (not indicated) spaced at least in part laterally of the partially disassembled assembly 10 during a repair or maintenance procedure, which may occur inside or outside of a wastewater container or treatment tank.

A maintenance or repair operation may then be conducted on one or more filter modules 16 or one or more filter plates 16. The maintenance or repair operation may include shifting one or more of filter plates 14 upwardly relative to other filter plates lower in the respective filter module 16. One or more filter plates 14 may be lifted slightly, to disengage from lower-disposed filter plates, and moved laterally away from stacked filter modules 16, inside or outside the wastewater treatment tank. After repairs or maintenance has been completed, tie or clamping rods 24 are moved back towards filter modules or casings 16 and laid into channels 30, with lower ends 25 of the rods being inserted into, and attached to, base 12. Permeate caps 20 and 22 are replaced on top of filter module 16, with through-holes 34 aligned with respective tie or clamping rods 24. Tensioning elements 26 are subsequently reattached to upper ends 28 of or clamping rods 24 via through-holes 34.

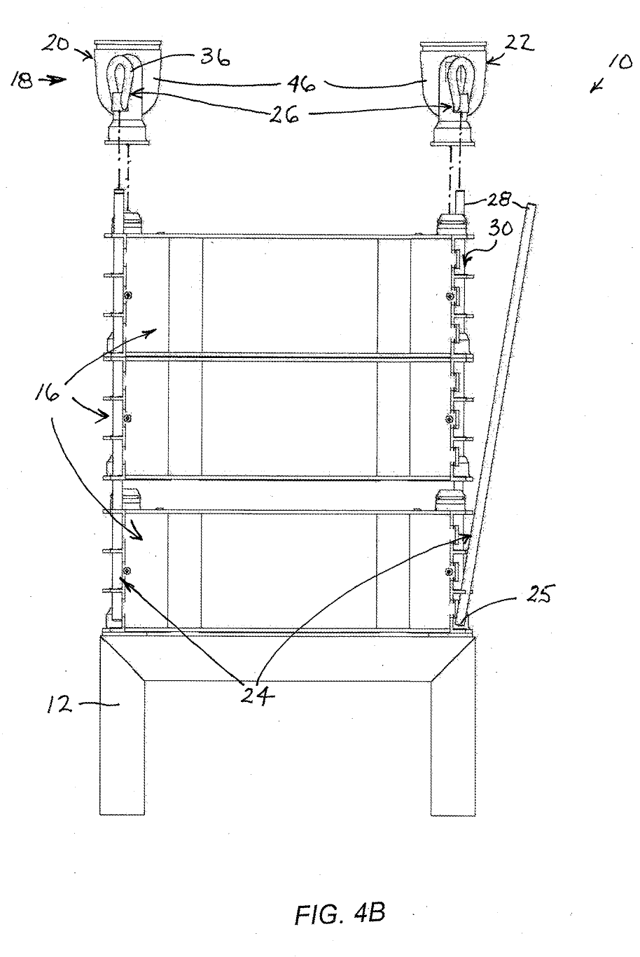

As illustrated in FIG. 7, a modular filter plate 14 for filter assembly 10 comprises a frame in the form of two end caps 40 and filter media 38 disposed between the end caps 40. Each end cap 40 includes at least one tubular protrusion 44 for liquid flow under negative pressure exerted via ports 46 in permeate caps 20 and 22. Tubular protrusions 44 are matingly engageable with corresponding recesses or holes (not illustrated) inside a respective filter module or casing 16. Filter plates 14 are rectangular or square with four corners. Each end cap 40 includes at least one tabular protrusion 45 that together with protrusions 44 ensure vertical orientation of the filter plates 14 in filter nodules or casings 16.

FIGS. 8 and 9 depict the filter assembly 10, wherein tie or clamping rods 24 are provided at their lower ends 25 with a cross-bar 48. Base 12 is formed along a vertical wall or panel 50 with a cutout 52 having a horizontal portion 54 communicating with a vertical portion 56. Vertical cutout portion 56 communicates with a slot 57 in an upper wall or panel 51 of base 12. In connecting the lower end 25 of tie or clamping rod 24 to base 12, cross-bar 48 and lower end 25 are inserted through horizontal portion 54 and vertical portion 56, respectively. The tie or clamping rod 24 is then elevated so that cross-bar 48 comes into contact with an underside of upper panel 50. These steps are naturally performed in reverse prior to a sideways moving of the tie or clamping rod 24 as described herein.

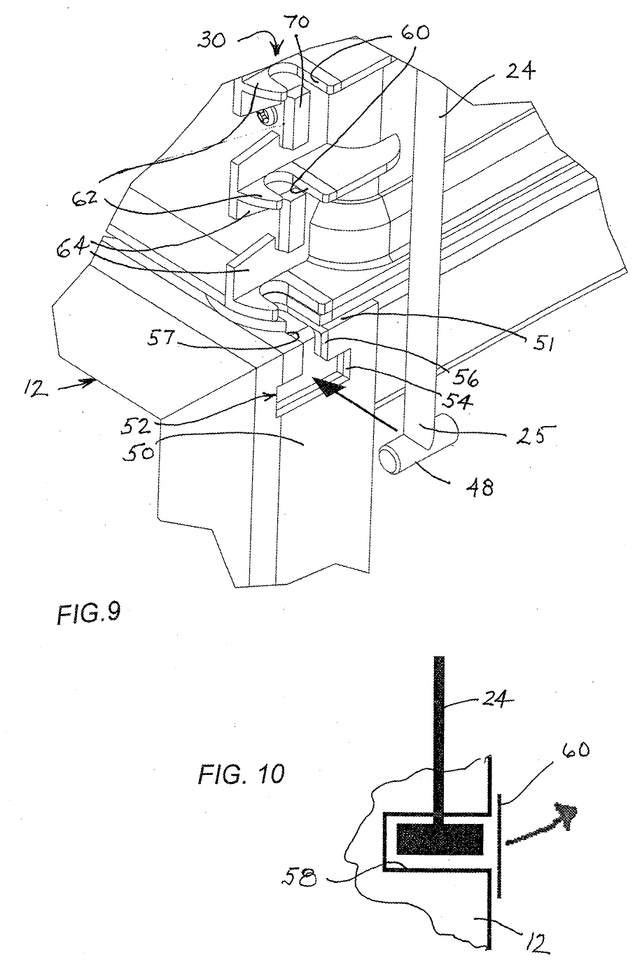

As depicted in FIG. 10, base 12 may be formed with a recess 58 communicating with a vertical slot (not shown in FIG. 10, but see FIG. 9). Cross-bar 48 is inserted into recess 58 and held therein by a cover plate 60 attachable to base 12, for instance, via pins, bolts, snap-lock elements, etc.

Although the invention has been described in terms of particular embodiments and applications, one of ordinary skill in the art, in light of this teaching, can generate additional embodiments and modifications without departing from the spirit of or exceeding the scope of the claimed invention. For instance, instead of being incorporated in permeate headers or caps 20 and 22, tie or clamping rods 24 can captured in other ways. The upper ends 28 of tie or clamping rods 24 may be fixed by respective brackets or holders.

In another alternative configuration, tie or clamping rods 24 may be laterally spaced, preferably by a slight distance, from the outer sides of the filter module or casing, rather than ensconced within laterally open channels or aligned slots.

While the one or more laterally removable tie rods 24 are preferably located at or near the corners or vertical edges of filter modules or casings 16, in one potential embodiment two rods may be located on the same side of the filter-module stack, not quite in the corners, but rather ⅓ to ¼ of the way from the corners.

Accordingly, it is to be understood that the drawings and descriptions herein are proffered by way of example to facilitate comprehension of the invention and should not be construed to limit the scope thereof.

What is claimed is:

1. An assembly for filtering water in wastewater and water treatment applications, comprising:
a base;
at least one filter module or casing supported on said base;
a plurality of filter plates disposed in said at least one filter module or casing;
a header disposed on top of said filter module;
a plurality of tie or clamping rods each coupled at a lower end to said base; and
a plurality of tensioning elements removably connected to upper ends of respective ones of said tie or clamping rods so that said tie or clamping rods press said at least one filter module or casing into rigid relationship with said base,
wherein said tie or clamping rods are disposed along an outer side of said filter module or casing so that at least one of said tie or clamping rods can be moved at least partially laterally away from said at least one filter module or casing upon a loosening or removal of a respective one of said tensioning elements from said at least one of said tie or clamping rods.

2. The assembly defined in claim 1 wherein said at least one filter module or casing is provided along said outer side with at least one laterally open elongate vertically extending channel, said at least one of said tie or clamping rods being disposed in and traversing said at least one laterally open elongate vertically extending channel.

3. The assembly defined in claim 2 wherein said at least one filter module or casing is provided along said outer side with a plurality of laterally open elongate vertically extending channels, said at least one laterally open elongate vertically extending channel being one of said laterally open elongate vertically extending channels, said tie or clamping rods being disposed in and traversing respective ones of said laterally open elongate vertically extending channels.

4. The assembly defined in claim 1 wherein said header includes at least one permeate cap, at least a given one of said tie or clamping rods releasably fixing said permeate cap relative to said at least one filter module or casing and said base.

5. The assembly defined in claim 4 wherein said permeate cap is provided with at least one through-hole, said at least a given one of said tie or clamping rods traversing said through-hole.

6. The assembly defined in claim 1 wherein each of said tie or clamping rods is provided at an upper end with an external screw thread, said tensioning elements having bores with internal screw threads so that said tensioning elements screwingly mate with the upper ends of said tie or clamping rods.

7. The assembly defined in claim 1 wherein:
said at least one filter module or casing has the form of a right rectangular prism;
said tie or clamping rods are four in number;
said at least one filter module or casing is provided along said outer side with a plurality of laterally open elongate vertically extending channels;
said laterally open elongate channels are disposed at respective vertically extending edges of said at least one filter module or casing; and
each of said tie or clamping rods is located in a respective one of said laterally open elongate channels.

8. The assembly defined in claim 6 wherein:
said header includes two permeate caps;
said first and said second permeate filter cap are located along respective opposing edges of said at least one filter module or casing;
each of said two permeate caps having two through-holes spaced from one another; and
said tie or clamping rods are connected to respective ones of said tensioning elements via respective ones of said through-holes.

9. The assembly defined in claim 1 wherein said tie or clamping rods are threadingly engaged with respective ones of said tensioning elements.

10. The assembly defined in claim 1 wherein the lateral moving of said one of said tie or clamping rods includes pivoting same about the respective lower end.

11. The assembly defined in claim 1 wherein said tensioning elements include a loop or hook, thereby enabling an entrainment of said tie or clamping rods via said tensioning elements and a lifting of the entire assembly.

12. The assembly defined in claim 1 wherein said filter module or casing is one of a plurality of filter modules or casings each containing a plurality of filter plates, said tensioning elements being removably connected to upper ends of respective ones of said tie or clamping rods so that said tie or clamping rods press said filter modules or casings into rigid relationship with each other and with said base.

13. A method for use in wastewater and water treatment applications, comprising:
providing a filter assembly including a base, at least one filter module or casing, a plurality of filter plates disposed in a stacked configuration in said filter module or casing atop said base, a header disposed on top of said filter module or casing, a plurality of tie or clamping rods each coupled at a lower end to said base, and a plurality of tensioning elements;
removably connecting said tensioning elements to upper ends of respective ones of said tie or clamping rods so that said tie or clamping rods press said at least one filter module or casing into rigid relationship with said base;
disposing said filter assembly in a wastewater container of wastewater;
subsequently removing at least one of said tensioning elements from the upper end of the respective one of said tie or clamping rods;
after the removing of said at least one of said tensioning elements, moving the respective one of said tie or clamping rods laterally away from said filter module or casing;
thereafter conducting a maintenance or repair operation on said filter module or casing or one or more of said filter plates;
thereafter moving said respective one of said tie or clamping rods back towards said filter module, laterally relative thereto; and
subsequently reattaching said at least one of said tensioning elements to the upper end of the respective one of said tie or clamping rods.

14. The method defined in claim 12 wherein said filter module or casing is provided along an outer side with at least one respective laterally open channel extending vertically along said outer side, the moving of said respective one of said tie or clamping rods laterally back towards said filter module including inserting said respective one of said tie or clamping rods into said at least one respective laterally open channel.

15. The method defined in claim 12, wherein said maintenance or repair operation includes shifting one or more of said filter plates relative to other ones of said filter plates in said filter module or casing.

16. The method defined in claim 12, wherein the moving of the respective one of said tie or clamping rods laterally away from said filter module or casing includes pivoting said respective one of said tie or clamping rods about a respective one of said lower ends thereof.
